(19) United States
(12) Patent Application Publication
(10) Pub. No.: US 2014/0372230 A1
(43) Pub. Date: Dec. 18, 2014

(54) SYSTEMS AND METHODS FOR SELECTING AND SERVING CONTENT ITEMS BASED ON VIEW PROBABILITY

(71) Applicant: Google Inc., Mountain View, CA (US)

(72) Inventors: Jonathan William Ray, Venice, CA (US); Farnaz Azmoodeh, Marina Del Rey, CA (US); Eric Wood, Los Angeles, CA (US); Congxing Cai, Los Angeles, CA (US); Paul Schelte Albert Reitsma, Marina Del Rey, CA (US); Glenn Wilson, Los Angeles, CA (US); Peng Zhang, Los Angeles, CA (US); Troy Louis Walker, Santa Monica, CA (US)

(73) Assignee: Google Inc., Mountain View, CA (US)

(21) Appl. No.: 13/972,379

(22) Filed: Aug. 21, 2013

Related U.S. Application Data
(63) Continuation of application No. 13/916,407, filed on Jun. 12, 2013.

(51) Int. Cl. G06Q 30/02

(52) U.S. Cl. CPC G06Q 30/0275
USPC 705/14.71

(57) ABSTRACT

A system may select and serve content items based on a view probability. The view probability may be determined using a view probability predictive model and one or more current viewability variables. Based on the determined view probability output by the view probability predictive model, a content item may be selected and served. A script may be included with or otherwise associated with the data output to effect presentation of the selected content item. The script outputs data indicative of whether the served content item is viewed on a display of a device. The script may output data indicating that the served content item is viewed when at least a predetermined percentage of the pixels of the served content item are within a viewable region for a period of time. A served content item may be determined to not have been viewed if a predetermined period of time elapses.

### CROSS-REFERENCE TO RELATED PATENT APPLICATIONS

This application is a continuation of U.S. patent application Ser. No. 13/916,407, filed Jun. 12, 2013, and entitled “Systems and Methods for Selecting and Serving Content Items Based on View Probability,” the disclosure of which is hereby incorporated by reference in its entirety.

### BACKGROUND

In a networked environment, such as the Internet or other networks, first-party content providers can provide information for public presentation on resources, for example web pages, documents, applications, and/or other resources. The first-party content can include text, video, and/or audio information provided by the first-party content providers via, for example, a resource server for presentation on a user device over the Internet. Additional third-party content can also be provided by third-party content providers for presentation on the user device together with the first-party content provided by the first-party content providers. Thus, a person viewing a resource can access the first-party content that is the subject of the resource, as well as the third-party content that may or may not be related to the subject matter of the resource.

### SUMMARY

One implementation relates to a method that includes receiving, at a processing module, view data. The view data includes data indicative of whether a previously served content item was viewed and one or more viewability variables. The method further includes generating a view probability predictive model based, at least in part, on the view data. One or more current viewability variables may be received, and a view probability may be determined based on the view probability predictive model and the received one or more current viewability variables. A value for a content item may be determined based, at least in part, on the view probability and a bid associated with the content item. The content item may be selected based, at least in part, on the determined value. Data to effect display of the selected content item may be outputted. Data indicating whether the selected content item was viewed may be received.

In another implementation, a system may include a processing module and a storage device storing instructions that, when executed by the processing module, cause the processing module to perform several operations. The operations may include receiving one or more viewability variables and determining a view probability based on a view probability predictive model and the received one or more viewability variables. The operations may also include determining a value for a content item based, at least in part, on the view probability and a bid associated with the content item and selecting the content item based, at least in part, on the value. The operations may include outputting data to effect display of the selected content item and receiving data indicating whether the selected content item was viewed.

In yet a further implementation, a non-transitory computer-readable storage device may store instructions that, when executed by a processing module, cause the processing module to perform several operations. The operations may include receiving one or more viewability variables and determining a view probability based on a view probability predictive model and the received one or more viewability variables. The operations may also include determining a value for a content item based, at least in part, on the view probability and a bid associated with the content item. The operations may further include selecting the content item based, at least in part, on the value and outputting data to effect display of the selected content item. The operations may further include receiving data indicating whether the selected content item was viewed.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is an overview depicting an example of a system for providing information via a network;

FIG. 2 is an overview depicting an example content item selection system;

FIG. 3 is an overview depicting an example resource having several content item slots;

FIG. 4 is an overview depicting another example resource on a mobile user device having several content item slots;

FIG. 5 is a flow diagram of an example process for generating a view probability predictive model based on view data and selecting and serving content items based on a view probability;

FIG. 6 is a flow diagram of an example process for selecting and serving content items based on a view probability from a received view probability predictive model;

FIG. 7 is another flow diagram of another example process for selecting and serving content items based on a view probability and outputting an impression cost if data received by the content item selection system indicates that the selected content item was viewed;

FIG. 8 is another flow diagram of an example process for generating a view probability predictive model using a script associated with a served content item; and

FIG. 9 is a block diagram illustrating a general architecture for a computer system that may be employed to implement various elements of the systems and methods described and illustrated herein.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Following below are more detailed descriptions of various concepts related to, and implementations of, methods, apparatuses, and systems for providing information on a computer network. The various concepts introduced above and discussed in greater detail below may be implemented in any of numerous ways, as the described concepts are not limited to any particular manner of implementation. Examples of specific implementations and applications are provided primarily for illustrative purposes.

A computing device (e.g., a user device) can view a resource, such as a web page, via the Internet by communicating with a server, such as a web page server, corresponding to that resource. The resource includes first-party content that is the subject of the resource from a first-party content provider, as well as additional third-party provided content, such as advertisements or other content. In one implementation, responsive to receiving a request to access a web page, a web page server and/or a user device can communicate with a data processing system, such as a content item selection system, to request a content item to be presented with the requested web page. The content item selection system can select a third-party content item and provide data to effect presentation of the content item with the requested web page on a display of the user device. In some instances, the content item is selected and served with a resource associated with a search query response. For example, a search engine may return search results on a search results web page and may include third-party content items related to the search query in one or more content item slots of the search results web page.

In some instances, a device identifier is associated with the user device. The device identifier may include a randomized number associated with the user device to identify the device during subsequent requests for resources and/or content items. In some instances, the device identifier is configured to store and/or cause the user device to transmit information related to the user device to the content item selection system and/or resource server (e.g., a web browser type, an operating system, prior resource requests, prior content item requests, etc.).

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

A third-party content provider, when providing third-party content items for presentation with requested resources via the Internet or other network, may utilize a content item management service to control or otherwise influence the selection and serving of the third-party content items. For instance, a third-party content provider may specify selection criteria (such as keywords) and corresponding bid values that are used in the selection of the third-party content items. The bid values may be utilized by the content item selection system in an auction to select and serve content items for display with a resource. For example, a third-party content provider may place a bid in the auction that corresponds to an agreement to pay a certain amount of money if a user interacts with the provider's content item (e.g., the provider agrees to pay $3 if a user clicks on the provider's content item). In other examples, a third-party content provider may place a bid in the auction that corresponds to an agreement to pay a certain amount of money if the content item is selected and served (e.g., the provider agrees to pay $0.005 each time a content item is selected and served). In some instances, the content item selection system uses content item interaction data to determine the performance of the third-party content provider's content items. For example, users may be more inclined to click on third-party content items on certain web pages over others. Accordingly, auction bids to place the third-party content items may be higher for high-performing web pages, categories of web pages, and/or other criteria, while the bids may be lower for low-performing web pages, categories of web pages, and/or other criteria.

In some instances, a web page or other resource (such as, for example, an application) includes one or more content item slots in which a selected and served third-party content item may be displayed. The code (e.g., JavaScript®, HTML, etc.) defining a content item slot for a web page or other resource may include instructions to request a third-party content item from the content item selection system to be displayed with the web page.

The selected and served content item displayed in a content item slot for the web page or other resource may not be within a viewable region of a display of a user device. For example, a web page may include additional content, including third-party content items in content item slots, which is not visible when the web page is initially displayed on a display of a user device. Such additional content, including third-party content items, may not be visible based on a variety of visibility variables. For example, a height of a web browser window, a width of a web browser window, a type of user device, a display type of a user device, dimensions of the display, a display resolution, a text size setting of the web browser of the user device, a font setting of the web browser, a zoom setting of the web browser, a dimension of one or more toolbar portions of the web browser, a dimension of one or more navigation and address portions of the web browser, a dimension of one or more bookmark portions of the web browser, a dimension of one or more tab portions of the web browser, a number of tabs open in the web browser, a dimension of a scroll bar of the web browser, a position of the content item slot in the web page, a type of web browser, whether third-party content item blocking services are implemented, and/or any other variable associated with the visibility of the additional content. In some instances, a user interacts with the user device to cause the additional content, including the third-party content items displayed in the content item slots, to become visible, such as through the use of an input device to scroll along the web page (e.g., via a mouse, touch screen, microphone, or other input device). In other instances, the user may navigate away from the web page without the additional content becoming visible.

During an auction for a content item slot for a resource, such as a web page, several different types of bid values may be utilized by third-party content providers for various third-party content items. For example, an auction may include bids based on whether a user clicks on the third-party content item, whether a user performs a specific action based on the presentation of the third-party content item, whether the third-party content item is selected and served, and/or other types of bids. For example, a bid based on whether the third-party content item is selected and served may be a lower bid (e.g., $0.005) while a bid based on whether a user performs a specific action may be a higher bid (e.g., $5). In some instances, the bid may be adjusted to account for the probability associated with the bid. For example, the probability of the user performing the specific action may be low, such as 0.2%, while the probability of the selected and served third-party content item may be 100% (e.g., the selected and served content item will occur if it is selected during the auction, so the bid is unadjusted). Accordingly, a value may be generated to be used in the auction based on the bid value and the probability or other modifying value associated with the bid. In the prior example, the value for the bid based on whether the third-party content item is selected and served is $0.005*1.00=0.005 and the value for the bid based on whether a user performs a specific action is $5*0.002=0.01. To maximize the income generated, the content item selection system may select the third-party content item with the highest value from the auction. Thus, the content item selection system may select the content item associated with the bid based on whether the user performs the specific action.

In instances where third-party content provider places a bid based on whether the third-party content item is selected and served, the third-party content provider may pay or be billed for the selected and served third-party content item regardless of whether the served third-party content item is within a viewable region of a display of a user device to be viewed by a user or not. Thus, in some instances, a third-party content provider may pay or be billed for selected and served content items that are not seen by a user (for example, the content item may be served in a content item slot on a lower portion of a web page and the user may not scroll down far enough for the content item to be visible). A third-party content provider may prefer to bid on and/or pay for third-party content items that are viewed by a user (e.g., are within a viewable region of a display of a user device).

The content item selection system may permit a third-party content provider to submit bids based on whether a content item is viewed and may include a view probability prediction model that outputs a view probability that a selected and served content item will be viewed by a user. The view probability is a probability that a selected and served content item or a portion thereof will be displayed in a viewable region of a display of a user device (e.g., visible on the screen of a user device).

The view probability prediction model may be generated based on prior data for whether a content item was viewed and one or more viewability variables. The viewability variables may be based on characteristics of the user device (e.g., a type of user device, a display type of a user device, dimensions of the display), characteristics of a web browser executed on the user device (e.g., a type of web browser), settings associated with the user device (e.g., a display resolution, whether third-party content item blocking services are implemented), settings associated with the web browser executed on the user device (e.g., a height of a web browser window, a width of a web browser window, a text size setting of the web browser of the user device, a font setting of the web browser, a zoom setting of the web browser, a dimension of one or more toolbar portions of the web browser, a dimension of one or more navigation and address portions of the web browser, a dimension of one or more bookmark portions of the web browser, a dimension of one or more tab portions of the web browser, a number of tabs open in the web browser, a dimension of a scroll bar of the web browser, formulae derived from dimensions of a web browser window and/or location of an area where a content item may be shown), and/or characteristics of the resource with which the content item is to be presented (e.g., a position of the content item slot in the resource, a category of the resource, a type of the resource, an interactivity level of the resource, a ranking of the resource, a popularity of the resource, dimensions of an area where a content item may be shown, part or all of an address of the resource).

The content item selection system receives one or more current viewability variables for a content item slot of a resource for an auction to select and serve a third-party content item for that content item slot. The one or more current viewability variables may similarly include characteristics of the user device (e.g., a type of user device, a display type of a user device, dimensions of the display), characteristics of a web browser executed on the user device (e.g., a type of web browser), settings associated with the user device (e.g., a display resolution, whether third-party content item blocking services are implemented), settings associated with the web browser executed on the user device (e.g., a height of a web browser window, a width of a web browser window, a text size setting of the web browser of the user device, a font setting of the web browser, a zoom setting of the web browser, a dimension of one or more toolbar portions of the web browser, a dimension of one or more navigation and address portions of the web browser, a dimension of one or more bookmark portions of the web browser, a dimension of one or more tab portions of the web browser, a number of tabs open in the web browser, a dimension of a scroll bar of the web browser, formulae derived from dimensions of a web browser window and/or location of an area where a content item may be shown), and/or characteristics of the resource with which the content item is to be presented (e.g., a position of the content item slot in the resource, a category of the resource, a type of the resource, an interactivity level of the resource, a ranking of the resource, a popularity of the resource, dimensions of an area where a content item may be shown, part or all of an address of the resource).

The one or more current viewability variables are input into the view probability predictive model to determine a view probability. A bid is determined based on the view probability of a content item output by the view probability predictive model for the auction. The values associated with each content item in the auction may be compared and the highest value is selected. Data to effect display of the selected content item may be output to the user device such that the selected content item may be shown on a display of the user device.

A script may be included with the data to effect display of the selected content item. The script may be configured to send data to the content item selection system and/or another system in response to an indication that the content item was viewed (e.g., displayed in a viewable region of a display of a user device). The content item selection system and/or another system may then bill the third-party content provider for the viewed content item.

In some instances, the data indicating that the content item was viewed and the received current viewability variables may be utilized to further update and refine the view probability predictive model.

While the foregoing has provided an overview of a content item selection system that permits the use of a bid based on whether a content item is viewed and a view probability predictive model, more specific examples and systems to implement such a system will now be described.

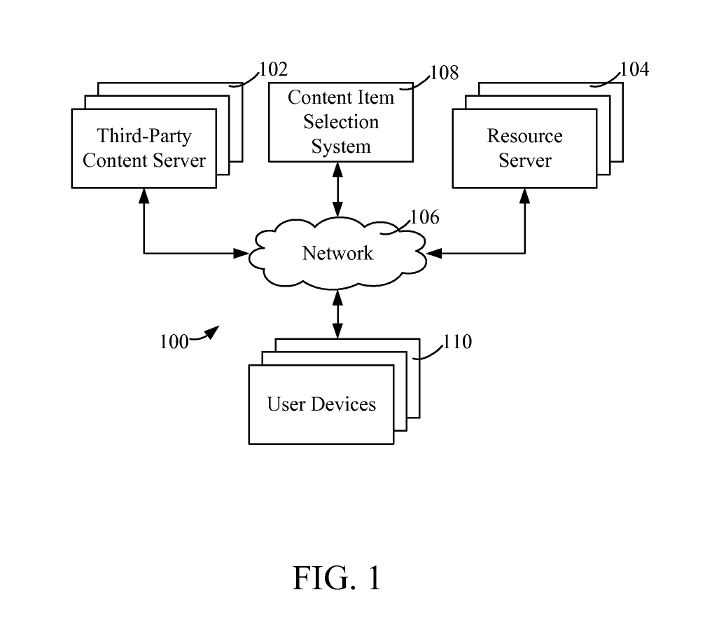

FIG. 1 is a block diagram of an example system 100 for providing information via at least one computer network such as the network 106. The network 106 may include a local area network (LAN), wide area network (WAN), a telephone network, such as the Public Switched Telephone Network (PSTN), a wireless link, an intranet, the Internet, or combinations thereof. The system 100 can also include at least one data processing system or processing module, such as a content item selection system 108. The content item selection system 108 can include at least one logic device, such as a computing device having a data processor, to communicate via the network 106, for example with a resource server 104, a user device 110, and/or a third-party content server 102. The content item selection system 108 can include one or more data processors, such as a content placement processor, configured to execute instructions stored in a memory device to perform one or more operations described herein. In other words, the one or more data processors and the memory device of the content item selection system 108 may form a processing module. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, C, C++, C#, Java®, JavaScript®, Perl®, HTML, XML, Python®, and Visual Basic®. The processing module may process instructions and output data to effect presentation of one or more content items to the resource server 104 and/or the user device 110. In addition to the processing circuit, the content item selection system 108 may include one or more databases configured to store data. The content item selection system 108 may also include an interface configured to receive data via the network 106 and to provide data from the content item selection system 108 to any of the other devices on the network 106. The content item selection system 108 can include a server, such as an advertisement server or otherwise.

The user device 110 can include one or more devices such as a computer, laptop, desktop, smart phone, tablet, personal digital assistant, set-top box for a television set, a smart television, or server device configured to communicate with other devices via the network 106. The device may be any form of portable electronic device that includes a data processor and a memory, i.e., a processing module. The memory may store machine instructions that, when executed by a processor, cause the processor to perform one or more of the operations described herein. The memory may also store data to effect presentation of one or more resources, content items, etc. on the computing device. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, C, C++, C#, Java®, JavaScript®, Perl®, HTML, XML, Python®, and Visual Basic®.

The user device 110 can execute a software application (e.g., a web browser or other application) to retrieve content from other computing devices over network 106. Such an application may be configured to retrieve first-party content from a resource server 104. In some cases, an application running on the user device 110 may itself be first-party content (e.g., a game, a media player, etc.). In one example, the user device 110 may execute a web browser application which provides a browser window on a display of the user device. The web browser application that provides the browser window may operate by receiving input of a uniform resource locator (URL), such as a web address, from an input device (e.g., a pointing device, a keyboard, a touch screen, or another form of input device). In response, one or more processors of the user device executing the instructions from the web browser application may request data from another device connected to the network 106 referred to by the URL address (e.g., a resource server 104). The other device may then provide web page data and/or other data to the user device 110, which causes visual indicia to be displayed by the display of the user device 110. Accordingly, the browser window displays the retrieved first-party content, such as web pages from various websites, to facilitate user interaction with the first party content.

The resource server 104 can include a computing device, such as a server, configured to host a resource, such as a web page or other resource (e.g., articles, comment threads, music, video, graphics, search results, information feeds, etc.). The resource server 104 may be a computer server (e.g., a file transfer protocol (FTP) server, file sharing server, web server, etc.) or a combination of servers (e.g., a data center, a cloud computing platform, etc.). The resource server 104 can provide resource data or other content (e.g., text documents, PDF files, and other forms of electronic documents) to the user device 110. In one implementation, the user device 110 can access the resource server 104 via the network 106 to request data to effect presentation of a resource of the resource server 104.

One or more third-party content providers may have third-party content servers 102 to directly or indirectly provide data for third-party content items to the content item selection system 108 and/or to other computing devices via network 106. The content items may be in any format that may be presented on a display of a user device 110, for example, graphical, text, image, audio, video, etc. The content items may also be a combination (hybrid) of the formats. The content items may be banner content items, interstitial content items, pop-up content items, rich media content items, hybrid content items, etc. The content items may also include embedded information such as hyperlinks, metadata, links, machine-executable instructions, annotations, etc. In some instances, the third-party content servers 102 may be integrated into the content item selection system 108 and/or the data for the third-party content items may be stored in a database of the content item selection system 108.

In one implementation, the content item selection system 108 can receive, via the network 106, a request for a content item to present with a resource. The received request may be received from a resource server 104, a user device 110, and/or any other computing device. The resource server 104 may be owned or ran by a first-party content provider that may include instructions for the content item selection system 108 to provide third-party content items with one or more resources of the first-party content provider on the resource server 104. In one implementation, the resource may include a web page. The user device 110 may be a computing device operated by a user (represented by a device identifier), which, when accessing a resource of the resource server 104, can make a request to the content item selection system 108 for content items to be presented with the resource, for instance. The content item request can include requesting device information (e.g., a web browser type, an operating system type, one or more previous resource requests from the requesting device, one or more previous content items received by the requesting device, a language setting for the requesting device, a geographical location of the requesting device, a time of a day at the requesting device, a day of a week at the requesting device, a day of a month at the requesting device, a day of a year at the requesting device, a type of user device, a display type of a user device, dimensions of the display, a display resolution, whether third-party content item blocking services are implemented, a height of a web browser window, a width of a web browser window, a text size setting of the web browser of the user device, a font setting of the web browser, a zoom setting of the web browser, a dimension of one or more toolbar portions of the web browser, a dimension of one or more navigation and address portions of the web browser, a dimension of one or more bookmark portions of the web browser, a dimension of one or more tab portions of the web browser, a number of tabs open in the web browser, a dimension of a scroll bar of the web browser, etc.) and resource information (e.g., URL of the requested resource, one or more keywords of the content of the requested resource, text of the content of the resource, a title of the resource, a position of the content item slot in the resource, a category of the resource, a type of the resource, an interactivity level of the resource, a ranking of the resource, a popularity of the resource, etc.). The information that the content item selection system 108 receives can include a HyperText Transfer Protocol (HTTP) cookie which contains a device identifier (e.g., a random number) that represents the user device 110. In some implementations, the device information and/or the resource information may be appended to a content item request URL (e.g., http://contentitem.item/page/contentitem?devid=abc123&devnfo=A34r0). The requesting device information and/or the resource information may be utilized by the content item selection system 108 to select third-party content items to be served with the requested resource and presented on a display of a user device 110.

In some instances, a resource of a resource server 104 may include a search engine feature. The search engine feature may receive a search query (e.g., a string of text) via an input feature (an input text box, etc.). The search engine may search an index of documents (e.g., other resources, such as web pages, etc.) for relevant search results based on the search query. The search results may be transmitted as a second resource to present the relevant search results, such as a search result web page, on a display of a user device 110. The search results may include web page titles, hyperlinks, etc. One or more third-party content items may also be presented with the search results in a content item slot of the search result web page. Accordingly, the resource server 104 and/or the user device 110 may request one or more content items from the content item selection system 108 to be presented in the content item slot of the search result web page. The content item request may include additional information, such as the user device information, the resource information, a quantity of content items, a format for the content items, the search query string, keywords of the search query string, information related to the query (e.g., geographic location information and/or temporal information), etc. In some implementations, a delineation may be made between the search results and the third-party content items to avert confusion.

In some implementations, the third-party content provider may manage the selection and serving of content items by content item selection system 108. For example, the third-party content provider may set bid values and/or selection criteria via a user interface that may include one or more content item conditions or constraints regarding the serving of content items. A third-party content provider may specify that a content item and/or a set of content items should be selected and served for user devices 110 having device identifiers associated with a certain geographic location or region, a certain language, a certain operating system, a certain web browser, etc. In another example, the third-party content provider may specify that a content item or set of content items should be selected and served when the resource, such as a web page, document, etc., contains content that matches or is related to certain keywords, phrases, etc. The third-party content provider may set a single bid value for several content items, set bid values for subsets of content items, and/or set bid values for each content item. The third-party content provider may also set the types of bid values, such as bids based on whether a user clicks on the third-party content item, whether a user performs a specific action based on the presentation of the third-party content item, whether the third-party content item is selected and served, and/or other types of bids.

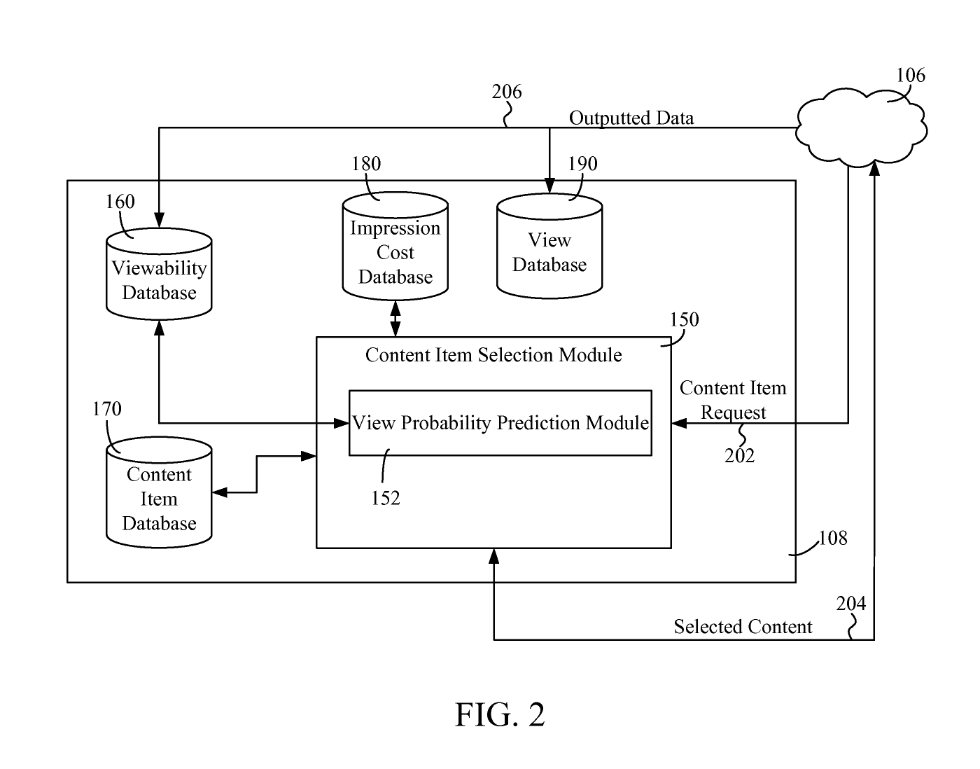

Referring now to FIG. 2, portions of the content item selection system 108 are shown in more detail. In the present example, the content item selection system 108 includes a content item selection module 150, a viewability database 160, a content item database 170, an impression cost database 180, and a view database 190. The content item selection module 150 includes a view probability prediction module 152. While the present example depicts the viewability database 160, the content item database 170, the impression cost database 180, and the view database 190 as separate databases, it should be understood that the databases may be combined into a single database or sets of databases (e.g., the view database 190 may be a part of the viewability database 160).

The content item selection module 150 is configured to receive a content item request 202 via the network 106. A user device, such as user device 110 of FIG. 1, or a resource server, such as resource server 104, may send the content item request 202 to the content item selection system 108 via the network 106. The content item request 202 may include one or more current viewability variables. The one or more current viewability variables may be based on characteristics of the user device (e.g., a type of user device, a display type of a user device, dimensions of the display), characteristics of a web browser executed on the user device (e.g., a type of web browser), settings associated with the user device (e.g., a display resolution, whether third-party content item blocking services are implemented), settings associated with the web browser executed on the user device (e.g., a height of a web browser window, a width of a web browser window, a text size setting of the web browser of the user device, a font setting of the web browser, a zoom setting of the web browser, a dimension of one or more toolbar portions of the web browser, a dimension of one or more navigation and address portions of the web browser, a dimension of one or more bookmark portions of the web browser, a dimension of one or more tab portions of the web browser, a number of tabs open in the web browser, a dimension of a scroll bar of the web browser, formulae derived from dimensions of a web browser window and/or location of an area where a content item may be shown), and/or characteristics of the resource with which the content item is to be presented (e.g., a position of the content item slot in the resource, a category of the resource, a type of the resource, an interactivity level of the resource, a ranking of the resource, a popularity of the resource, dimensions of an area where a content item may be shown, part or all of an address of the resource). In some implementations, the current viewability variables associated with the requesting device and/or the resource may be appended to a content item request URL (e.g., http://contentitem.item/page/contentitem?devid=abc123&devnfo=A34r0).

The current viewability variables for the content item request 202 are received by the view probability prediction module 152 and used with a view probability predictive model to output a view probability (e.g., a value between 0 and 1) that a served third-party content item will be viewed given the set of current viewability variables. The current viewability variables may be received with the content item request 202 (e.g., a script or function of the resource may output the current viewability variables as part of the content item request 202, such as appended to the content item request URL) or may be retrieved when the content item request 202 is initially received (e.g., by calling a script or function to output the current viewability variables). The received current viewability variables may be stored in the viewability database 160 and may be associated with a unique identifier, such as a unique identifier for the content item request 202. As will be discussed herein, the stored current viewability variables may be associated with data indicative of whether the served content item is viewed on a display of a device to update and refine a view probability predictive model.

In some implementations, the content item selection module 150 is also configured to retrieve or receive a view probability prediction model from the viewability database 160 for the view probability prediction module 152. The view probability prediction module 152 is configured to determine a view probability based on the view probability prediction model and the current viewability variables. That is, the view probability prediction module 152 inputs the current viewability variables into the view probability prediction model and generates a view probability as an output.

In some other implementations, the content item selection module 150 may be configured to retrieve or receive view data from the viewability database 160 for the view probability prediction module 152. The view data includes data about previously served content items that includes data indicative of whether each previously served content item was viewed and any viewability variables associated with the previously served content item. The view probability prediction module 152 may utilize the view data to generate the view probability prediction model.

For example, according to various implementations, the view probability prediction module 152 may generate the view probability predictive model using logistic regression based on the view data, as will be described in greater detail herein.

The output from the view probability predictive model is received by the content item selection module 150 and utilized with one or more bids associated with third party content items. For example, an effective cost per mille impressions (eCPM) may be calculated for each third-party content item by eCPM=VP*CPMV, where VP is the view probability and CPMV is the cost per mille viewable (CPMV) bid associated with the third-party content item. The content item selection module 150 is configured to perform an auction to select a content item, as will be discussed in greater detail below.

A viewed impression cost (IC) associated with the selected content item is determined by the content item selection module 150 and is stored in the impression cost database 180. In one example, the impression cost is stored in a record or log of the impression cost database 180. The impression cost may be associated with a unique identifier, such as a unique identifier for the content item request 202, such that the impression cost may be matched with data in the view database 190 if the selected content item is viewed, as will be described below. The impression cost may be determined by

$$IC = \frac{{eCPM}_{runner \text{-} up}}{1000 * VP} ,$$

where eCPMᵣᵤₙₙₑᵣ₋ᵤₚ is the next highest eCPM value. The impression cost may be billed or charged to the third-party content provider only if the served content item is viewed, as will be described in greater detail herein.

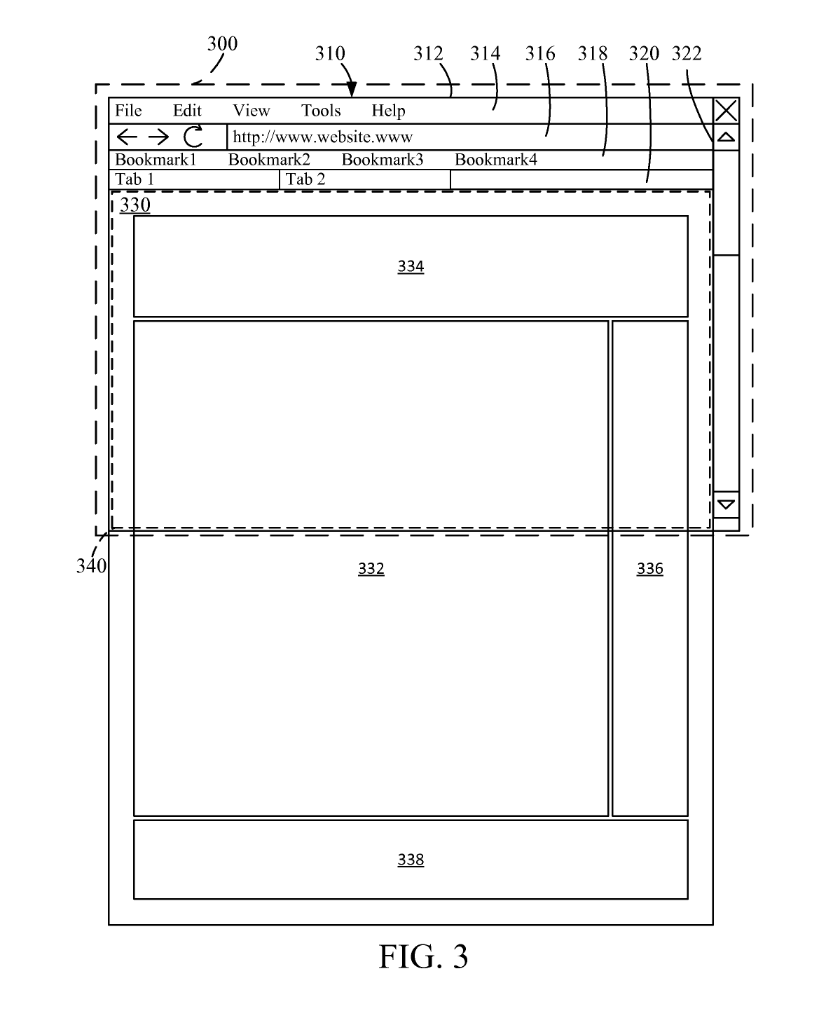

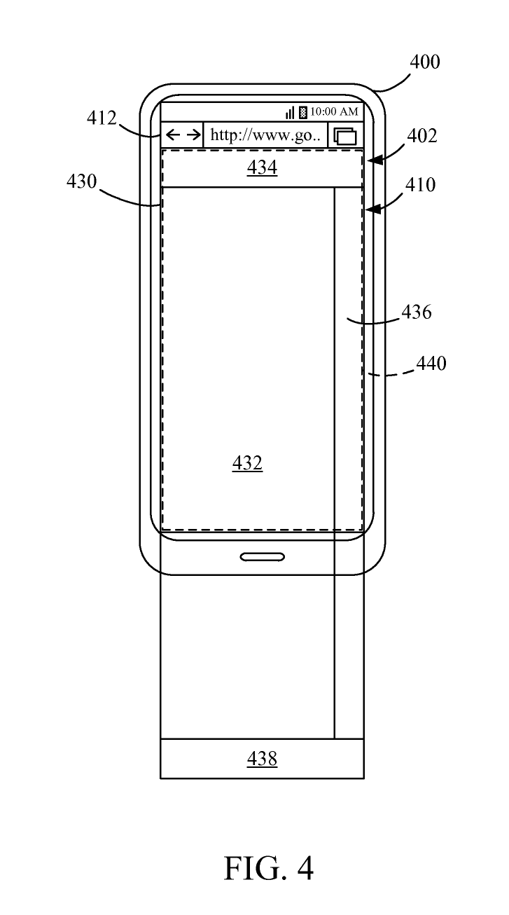

The content item selection module 150 is configured to retrieve the selected content item from the content item database 170 to be sent in response to the content item request 202. The content item selection module 150 includes or associates a script with the selected content item. For example, the script may be a JavaScript® script that can be embedded in the data to effect presentation of the selected content item or the script may simply be associated with the selected content item and sent with the data to effect presentation of the selected content item. The script is configured to immediately output data 206 to indicate if the served content item is viewed on a display of a device, such as the user device 110. The data 206 may include only data indicating that the served content item is viewed on a display of a device or the data 206 may also include the current viewability variables or other data. In some instances, the data 206 may be associated with a unique identifier, such as that for the content item request 202. The determination of whether the served content item is viewed will be described in greater detail in reference to FIGS. 3 and 4. In some implementations, the script may be configured to directly determine whether the served content item is viewed. In other implementations, the script may receive input from another script that monitors a viewable region with respect to the displayed resource and served content item.

The outputted data 206 may be stored in a record or log of the view database 190 and/or the viewability database 160. In implementations where the data 206 includes the data indicative of whether the served content item is viewed on a display of a device, the data 206 may be stored in view database 160 and may also be matched with the corresponding viewability variables in the viewability database 160 (e.g., by matching the unique identifiers) and stored with the current viewability variables in the viewability database 160. The data 206 stored in the view database 190 may be matched (on-demand, periodically, etc.) with the stored impression costs in the impression cost database 180 to determine which served content items and associated impression costs were viewed. The matching of the data 206 indicative of whether the served content item was viewed on a display of a device and the stored impression costs may be utilized such that a third-party content provider is only billed or charged for served content items that were viewed, as will be described in greater detail herein. In some implementations, the impression cost database 180 and view database 190 may be part of another system and the content item selection system 108 may transmit the impression cost data and/or the data 206 to the other system.

FIG. 3 depicts an example display 300 (shown in phantom) of a user device, such as user device 110 of FIG. 1, with a web browser 310 for displaying resources on the display 300. The web browser 310 includes a window 312 having a dimensional height and dimensional width. The dimensional height and/or dimensional width of the window 312 for the web browser 310 may be adjusted by a user (e.g., by clicking and dragging to resize the window). The web browser 310 of the present example also includes a toolbar portion 314, a navigation and address portion 316, a bookmark portion 318, a tab portion 320, and a scroll bar 322. The web browser 310 may operate by receiving input of a URL in the address bar of the navigation and address portion 316, such as a web address, from an input device (e.g., a pointing device, a keyboard, a touch screen, or another form of input device). In response, one or more processors of a user device executing the instructions from the web browser 310 may request data from another device connected to a network, such as network 106, referred to by the URL address (e.g., a resource server 104). The other device may then provide web page data and/or other data to the user device, which causes visual indicia to be displayed by the display of the user device. Accordingly, the web browser 310 displays a retrieved resource 330, such as a web page.

In the present example, the web browser 310 includes a viewable region 340 (shown in phantom) in which the resource 330 and/or portions thereof may be displayed. A variety of variables may affect the size of the viewable region 340. For example, the variables that may affect the size of the viewable region 340 may include characteristics of the user device (e.g., a type of user device, a display type of a user device, dimensions of the display), characteristics of the web browser 310 executed on the user device (e.g., a type of web browser), settings associated with the user device (e.g., a display resolution, whether third-party content item blocking services are implemented), and/or settings associated with the web browser 310 executed on the user device (e.g., the height of the window 312 of the web browser 310, the width of the window 312 of the web browser 310, a text size setting of the web browser 310, a font setting of the web browser 310, a zoom setting of the web browser 310, a dimension of one or more toolbar portions 314 of the web browser 310, a dimension of one or more navigation and address portions 316 of the web browser 310, a dimension of one or more bookmark portions 318 of the web browser 310, a dimension of one or more tab portions 320 of the web browser 310, a number of tabs open in the web browser 310, a dimension of a scroll bar 322 of the web browser 310). By way of example, a viewable region 340 may be large for a large display with a high display resolution, a large height and width for the window 312 of the web browser 310 with small dimensions for the toolbar portion 314, the navigation and address portion 316, the bookmark portion 318, the tab portion 320, and the scroll bar 322. Conversely, the viewable region 340 may be smaller for a small display with a low display resolution, a small height and width for the window 312 of the web browser 310 and large dimensions for several toolbar portions 314, the navigation and address portion 316, the bookmark portion 318, the tab portion 320, and the scroll bar 322. In some instances, one or more of the toolbar portion 314, the navigation and address portion 316, the bookmark portion 318, the tab portion 320, and the scroll bar 322 may be omitted. In addition, it should be understood that several toolbars may be installed on the user device for the toolbar portion 314.

An example resource 330 is shown displayed by the display 300 of the user device in the viewable region 340 of the web browser 310. The resource 330 includes a first party content portion 332, a first content item slot 334, a second content item slot 336, and a third content item slot 338. In the present example, the first content item slot 334 is shown completely within the viewable region 340 while the first party content portion 332 and the second content item slot 336 are partially shown in the viewable region 340. The third content item slot 338 is not shown within the viewable region 340.

The determination of whether a served content item is viewed may be based upon data indicating that at least a predetermined percentage of the pixels of the served content item are visible within the viewable region 340. The predetermined percentage may be from 0% of the pixels to 100% of the pixels, inclusive. For example, the predetermined percentage may be 5%, 10%, 15%, 20%, 25%, 30%, 35%, 40%, 45%, 50%, 55%, 60%, 65%, 70%, 75%, 80%, 85%, 90%, 95%, etc. In the present example, the predetermined percentage is 50%. In some implementations, the third-party content provider may select the predetermined percentage to be used. As shown in FIG. 3, a served content item in the first content item slot 334 may be determined to be viewed as 100% of the pixels of the served content item are within the viewable region 340. A content item served in the second content item slot 336 may be determined to not have been viewed yet as approximately 40% of the pixels of the served content item are within the viewable region 340. If, for example, the user utilizes the scroll bar 322 to scroll down the resource 330 such that at least 50% of the pixels are visible within the viewable region 340, then a determination may be made that a served content item in the second content item slot 336 has been viewed. A content item served in the third content item slot 338 may be determined to not have been viewed yet as none of the pixels of the served content item are within the viewable region 340. If, for example, the user utilizes the scroll bar 322 to scroll down the resource 330 such that at least 50% of the pixels of the served content item in the third content item slot 338 are visible within the viewable region 340, then a determination may be made that a served content item in the third content item slot 338 has been viewed.

As noted above in reference to FIG. 2, a script may be embedded or associated with the data to effect presentation of the served content items. The script may be configured to immediately output data to indicate if at least 50% of the pixels of the served content item are within the viewable region 340. In some implementations, the script may be configured to directly determine whether the served content item is viewed. In other implementations, the script may receive input from another script that monitors a viewable region 340 with respect to the displayed resource 330 and the served content item.

In some implementations, the determination that a served content item is viewed may also include a period of time for at least the predetermined percentage of the pixels of the served content item to be within the viewable region 340. For example, the period of time may be at least 0.5 seconds, 1 second, 2 seconds, 3 seconds, 4 seconds, 5 seconds, etc. In some implementations, the third-party content provider may select the period of time to be used. Thus, if a user rapidly scrolls past a served content item in a content item slot, then the content item may not be determined to have been viewed. For example, if 100% of the pixels of the served content item are within the viewable region 340 for 0.3 seconds and the period of time is 1 second, then the script or other script that sends input to the script associated with the served content item may determine that the served content item has not been viewed yet and data is not outputted to the content item selection system. In some implementations, the period of time may be a total period of time and not a contiguous period of time. Thus, if a served content item is viewed for a total amount of time greater than the period of time, even if not contiguous, then the served content item may be determined to have been viewed. For example, if a user scrolls past a served content item several times with periods of time that sum above the minimum period of time, then the script or other script that sends input to the script associated with the served content item may determine that the served content item has been viewed. In other implementations, the period of time may be a minimum contiguous period of time.

In some implementations, the determination of whether a served content item is viewed may be based upon data indicating that a measurement pixel (e.g., a pixel having a unique identifier or other data to identify the pixel) is within the viewable region 340. The measurement pixel may be associated with a logo of the served content item, a main image or subject of the served content item, text of the content item, a link of the content item, and/or other portions of the content item. In some instances, the measurement pixel may be positioned at a midpoint of the height and width of the served content item. In some implementations, a third-party content provider may select a pixel to be a measurement pixel to be used. In still further implementations, several measurement pixels may be utilized.

In yet other implementations, regions of several pixels of the served content item may be utilized to determine whether the served content item is viewed. For example, the pixels of a logo of the served content item may be the region of several pixels. Accordingly, if at least a predetermined percentage of the pixels of logo of the served content item are visible within the viewable region 340, then the script or other script that sends input to the script associated with the served content item may determine that the served content item has been viewed. The region of several pixels may be a region of pixels corresponding to a main image or subject of the served content item, text of the content item, a link of the content item, and/or any other region of pixels of the content item. In some implementations, a third-party content provider may select a region of pixels to be used. Of course, still further implementations to determine whether the served content item has been viewed relative to the viewable region 340 may be used as well.

The characteristics of the resource 330 with which a content item is to be presented in a content item slot 334, 336, 338 of the resource 330 may affect the probability that the select content item will be viewed. For example, a position of the content item slot 334, 336, 338 in the resource 330, a category of the resource 330, a type of the resource 330, an interactivity level of the resource 330, a ranking of the resource 330, a popularity of the resource 330, and/or other characteristics may affect the probability that a selected content item is viewed.

According to various implementations, data for the content of the resource 330 may be sent to the content item selection system 108 of FIGS. 1-2. The content of the resource 330 may be parsed for keyword terms to determine the category of the resource 330. For example, the content item selection system 108 may receive or extract keyword terms and determine a category for the resource 330 based on the keyword terms. In general, a category may be a set of words that convey the same or similar ideas. A word category may be a set of synonyms, according to one embodiment. For example, the text of the resource 330 may include the word “hotel.” A word category that includes the word “hotel” may be as follows:

category_{—}1={inn, hotel, hostel, lodge, motel, public house, spa}
Such a category may be used to identify resources 330 devoted to the same topic, but use different terminology to do so.

In various implementations, the type of the resource 330 may be determined based on the parsed keyword terms. For example, a resource 330 containing keyword terms for news may indicate a news article. In other implementations, the type of the resource 330 may be determined based on a structure of the resource 330. For example, the resource 330 having a first party content portion 332 having a long vertical textual portion may correspond to an article type of resource 330. In other instances, a first party content portion 332 having several images may indicate and photo album type of resource 330. The type of the resource 330 may be useful for the view probability predictive model (e.g., an article type of resource may be more likely for a user to scroll through and read while a photo album may be quickly viewed and navigated away from).

The content item selection system 108 may also determine an interactivity level of the resource 330 based on the content of the resource 330. For example, a resource 330 having a web based game may be more interactive than a simple text resource 330. The content item selection system 108 may determine the interactivity level based on the data of the resource 330 (e.g., a JavaScript® file for a game or simple text).

The ranking and/or the popularity of a resource 330 may be retrieved from a metrics database or service. In some implementations, the ranking and/or popularity may be based on the traffic a resource receives over a period of time, such as traffic over the past hour, day, week, month, years, etc.

The position of the content item slot 334, 336, 338 in the resource 330, the category of the resource 330, the type of the resource 330, the interactivity level of the resource 330, the ranking of the resource 330, the popularity of the resource 330, and/or other characteristics of the resource 330 may be used as viewability variables for the view probability predictive model described herein.

FIG. 4 depicts a mobile user device 400, such as a smartphone, on which a resource 430 may be displayed by a display 402 of the user device. The user device 400 may utilize a web browser 410 for displaying resources on the display 402 of the user device 400. The web browser 410 of the present example includes a navigation and address portion 412 only, though it should be understood that a toolbar portion, a bookmark portion, a tab portion, and/or a scroll bar may also be included. The web browser 410 may operate by receiving input of a URL in the address bar of the navigation and address portion 412, such as a web address, from an input device, such as a keyboard displayed on the touch screen in the present example. In response, one or more processors of the user device 400 executing the instructions from the web browser 410 may request data from another device connected to a network, such as network 106, referred to by the URL address (e.g., a resource server 104). The other device may then provide web page data and/or other data to the user device 400, which causes visual indicia to be displayed by the display 402 of the user device 400. Accordingly, the web browser 410 displays a retrieved resource 430, such as a web page.

The web browser 410 includes a viewable region 440 (shown in phantom) in which the resource 430 and/or portions thereof may be displayed. A variety of variables may affect the size of the viewable region 440. For example, the variables that may affect the size of the viewable region 340 may include characteristics of the user device 400 (e.g., a type of user device, a display type of a user device, dimensions of the display), characteristics of the web browser 410 executed on the user device (e.g., a type of web browser), settings associated with the user device 400 (e.g., a display resolution, whether third-party content item blocking services are implemented), and/or settings associated with the web browser 410 executed on the user device (e.g., the height of the web browser 410, the width of the web browser 410, a text size setting of the web browser 410, a font setting of the web browser 410, a zoom setting of the web browser 410, a dimension of one or more toolbar portions of the web browser 410, a dimension of one or more navigation and address portions 412 of the web browser 410, a dimension of one or more bookmark portions of the web browser 410, a dimension of one or more tab portions of the web browser 410, a number of tabs open in the web browser 410, a dimension of a scroll bar of the web browser 410). By way of example, a viewable region 440 may be large for a large display with a high display resolution and a web browser 410 with a small dimension for the navigation and address portion 412. Conversely, the viewable region 440 may be smaller for a small display with a low display resolution and a web browser 410 with a large dimension for the navigation and address portion 412.

An example resource 430 is shown displayed by the display 402 of the user device 400 in the viewable region 440 of the web browser 410. The resource 430 includes a first party content portion 432, a first content item slot 434, a second content item slot 436, and a third content item slot 438. In the present example, the first content item slot 434 is shown completely within the viewable region 440 while the first party content portion 432 and the second content item slot 436 are partially shown in the viewable region 440. The third content item slot 438 is not shown within the viewable region 440.

The determination of whether a served content item is viewed may be based upon data indicating that at least a predetermined percentage of the pixels of the served content item are visible within the viewable region 440. The predetermined percentage may be from 0% of the pixels to 100% of the pixels, inclusive. For example, the predetermined percentage may be 5%, 10%, 15%, 20%, 25%, 30%, 35%, 40%, 45%, 50%, 55%, 60%, 65%, 70%, 75%, 80%, 85%, 90%, 95%, etc. In the present example, the predetermined percentage is 50%. In some implementations, the third-party content provider may select the predetermined percentage to be used. As shown in FIG. 4, a served content item in the first content item slot 434 may be determined to be viewed as 100% of the pixels of the served content item are within the viewable region 440. A content item served in the second content item slot 436 may also be determined to be viewed as approximately 60% of the pixels of the served content item are within the viewable region 440. A content item served in the third content item slot 438 may be determined to not have been viewed yet as none of the pixels of the served content item are within the viewable region 440. If, for example, the user scrolls along the resource 430, such as by using a finger to scroll using a touch screen of the user device 400, such that at least 50% of the pixels of the served content item in the third content item slot 438 are visible within the viewable region 440, then a determination may be made that a served content item in the third content item slot 438 has been viewed.

As noted above in reference to FIG. 2, a script may be embedded or associated with the data to effect presentation of the served content items. The script may be configured to immediately output data to indicate if at least 50% of the pixels of the served content item are within the viewable region 440. In some implementations, the script may be configured to directly determine whether the served content item is viewed. In other implementations, the script may receive input from another script that monitors a viewable region 440 with respect to the displayed resource 430 and the served content item.

Of course any of the implementations described above in reference to FIG. 3 may be utilized with the user device 400 and resource 430 of FIG. 4.

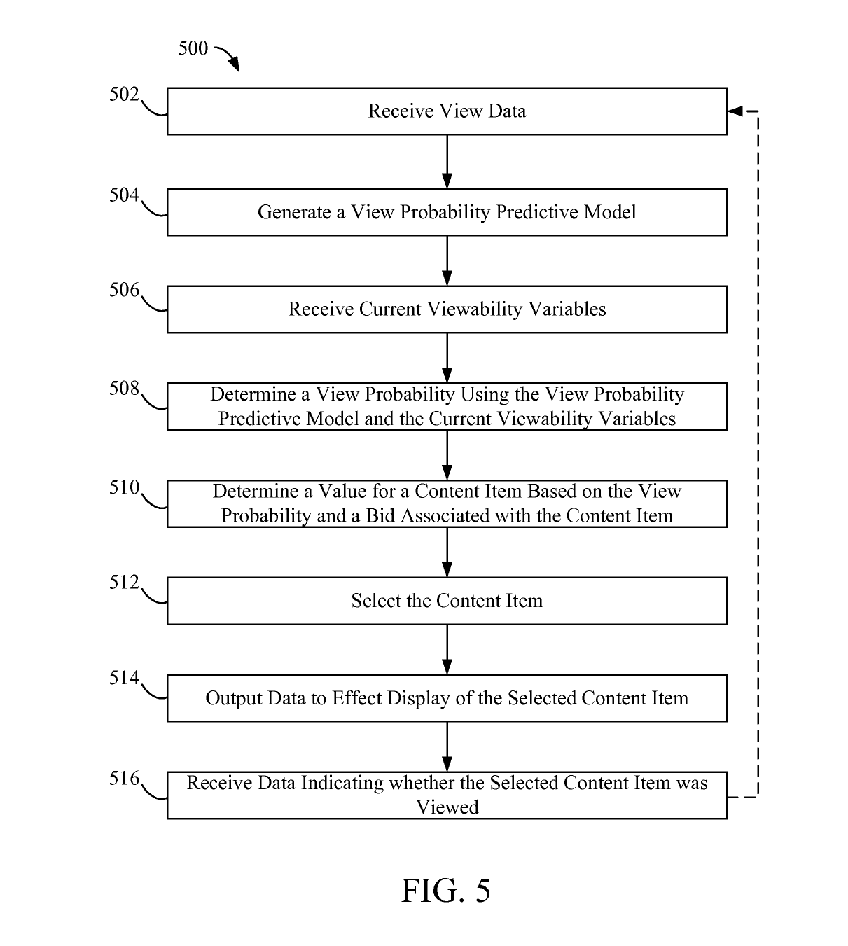

FIG. 5 depicts a flow diagram of an example process 500 for generating a view probability predictive model based on view data and selecting and serving content items based on a view probability. The content item selection system 108 may receive view data (step 502) from the viewability database 160. The view data includes data about previously served content items that includes data indicative of whether each previously served content item was viewed and any viewability variables associated with the previously served content item. The viewability variables may be based on characteristics of the user device (e.g., a type of user device, a display type of a user device, dimensions of the display), characteristics of a web browser executed on the user device (e.g., a type of web browser), settings associated with the user device (e.g., a display resolution, whether third-party content item blocking services are implemented), settings associated with the web browser executed on the user device (e.g., a height of a web browser window, a width of a web browser window, a text size setting of the web browser of the user device, a font setting of the web browser, a zoom setting of the web browser, a dimension of one or more toolbar portions of the web browser, a dimension of one or more navigation and address portions of the web browser, a dimension of one or more bookmark portions of the web browser, a dimension of one or more tab portions of the web browser, a number of tabs open in the web browser, a dimension of a scroll bar of the web browser), and/or characteristics of the resource with which the content item is to be presented (e.g., a position of the content item slot in the resource, a category of the resource, a type of the resource, an interactivity level of the resource, a ranking of the resource, a popularity of the resource).

The content item selection system 108 may generate a view probability predictive model based on the received view data (step 504). In some implementations, the content item selection system 108 may generate the view probability predictive model. In other implementations, the view probability prediction module 152 of the content item selection system 108 may be utilized to generate the view probability prediction model. According to various implementations, the view probability prediction module 152 may generate the view probability predictive model using logistic regression based on the received view data. For example, according to various implementations, the view probability prediction module 152 may generate the view probability predictive model using logistic regression based on the view data. A logistic regression function may be defined as

$$f ( z ) = \frac{1}{1 + {e}^{- z}} .$$

The output, f(z), of the view probability predictive model represents the view probability (e.g., a value between 0 and 1) that a served third-party content item will be viewed given a set of viewability variables. The viewability variables of the received view data may correspond to inputs x₁ through xₖ for the equation z=βₒ+β₁x₁+β₂x₂+ . . . +βₖxₖ that is input into the logistic regression function. β₀ is the y-axis intercept, x₁ is an input variable affecting the probability outcome, and β₁ through βₖ are regression coefficients or weights (e.g., determining how much each variable x₁ affects the outcome). Variable coefficients β₁, β₂, etc. are used to weigh the importance of each input variable according to its overall effect on probability output. A large regression coefficient means that the variable strongly influences the probability of that outcome, while a near-zero regression coefficient means that that variable has little influence on the probability of that outcome. In some implementations, the inputs to the model may be cross products of input values.

Training of the logistic regression model may be achieved by utilizing a corpus of known results from the received view data, such as the data indicative of whether each previously served content item was viewed, along with the corresponding viewability variables. According to some implementations, a comparison between the outputted view probability and the known results will provide a measurement of error that can be used to adjust the regression coefficients or weights β₁-βₖ, to minimize the error. The training may utilize additional data indicative of whether each previously served content item was viewed and the corresponding viewability variables such that the logistic regression model is continually updated to increase the accuracy of the model, as will be described in greater detail herein. Of course, other regression models may be used to generate the view probability predictive model, such as linear regression, naïve Bayesian, Bayesian linear regression, nonparametric regression, etc. In some implementations, an artificial neural network can be trained using the corpus of known results and the corresponding viewability variables.

The content item selection system 108 receives a set of current viewability variables (step 506). The set of current viewability variables may be based on characteristics of the user device (e.g., a type of user device, a display type of a user device, dimensions of the display), characteristics of a web browser executed on the user device (e.g., a type of web browser), settings associated with the user device (e.g., a display resolution, whether third-party content item blocking services are implemented), settings associated with the web browser executed on the user device (e.g., a height of a web browser window, a width of a web browser window, a text size setting of the web browser of the user device, a font setting of the web browser, a zoom setting of the web browser, a dimension of one or more toolbar portions of the web browser, a dimension of one or more navigation and address portions of the web browser, a dimension of one or more bookmark portions of the web browser, a dimension of one or more tab portions of the web browser, a number of tabs open in the web browser, a dimension of a scroll bar of the web browser), and/or characteristics of the resource with which the content item is to be presented (e.g., a position of the content item slot in the resource, a category of the resource, a type of the resource, an interactivity level of the resource, a ranking of the resource, a popularity of the resource).

The set of current viewability variables may be associated with a received content item request, such as content item request 202 of FIG. 2. For example, the set of current viewability variables may be output by a script, such as a JavaScript®, of a resource or output in response to a request to a web browser executed on the user device. In some implementations, the set of current viewability variables may be appended to a content item request URL (e.g., http://contentitem.item/page/contentitem?devid=abc123&devnfo=A34r0).

According to some implementations, the set of current viewability variables may be retrieved after the content item request is initially received (e.g., by calling a script or function to output a set of current viewability variables in response to receiving the content item request).

The received set of current viewability variables may be stored in the viewability database 160 and may be associated with a unique identifier, such as a unique identifier for the content item request. As will be discussed herein, the stored set of current viewability variables may be associated with data indicative of whether the served content item is viewed on a display of a device to update and refine the view probability predictive model, according to some implementations.

The content item selection system 108 determines a view probability (e.g., a value between 0 and 1) using the received set of current viewability variables and the generated view probability predictive model (step 508). The set of current viewability variables are input into the view probability predictive model for corresponding inputs x₁ through xₖ. In some implementations, if the set of current viewability variables omits a variable for an input of the view probability predictive model, a default value may be input. The default value may be an average value for that variable base on the received view data (step 502). In other implementations, the default value may be a zero value.

The content item selection system 108 determines a value for a content item based on the view probability and a bid associated with the content item (step 510). For example, the content item selection system 108 may determine a value, such as an eCPM, for each third-party content item using the equation eCPM=VP*CPMV, where VP is the determined view probability and CPMV is the CPMV bid associated with the third-party content item. The content item selection system 108 may determine values for several content items based on the determined view probability and the corresponding CPMV bid. In some implementations, the content item selection system 108 may rank the third-party content items based on the determined eCPM values prior to performing an auction. That is, the third-party content items having bids based on whether a content item is viewed may be ranked based on the determined eCPM values.

The content item selection system 108 selects a content item (step 512). The content item may be selected based on an auction performed by the content item selection system 108. The content item auction includes receiving third-party content provider submitted bids for the ability to provide content items for display with a resource presented on a display of a user device. The auction may include content items and associated bids based on whether a user clicks on the third-party content item, whether a user performs a specific action based on the presentation of the third-party content item, whether the third-party content item is selected and served, whether the third-party content item is viewed, and/or other types of bids. Values other than the value determined for a content item based on the view probability and a bid associated with the content item (step 510) may be determined for the other types of content items and associated bids. The content item selection system 108 selects the content item having an associated value that is the highest of the several values in the auction. By way of example, an auction may be between a content item having a bid based on whether the content item is viewed and a content item having a bid based on whether the content item is clicked. A determined view probability may be high, such as 0.8 (80%) while a predicted click-through-rate may be low, such as 0.05 (5%). If, for example, the bid based on whether the content item is viewed is high, such as $1.00, then the resulting determined value may be high, such as $0.80=0.8*$1.00. If the bid based on whether the content item is clicked is low, such as $5.00, then the resulting determined value may be low, such as $0.25=0.05*$5.00. Accordingly, the content item selection system 108 selects the content item having the bid based on whether the content item is viewed. Of course the foregoing is merely an example.

The content item selection system 108 outputs data to effect display of the selected content item (step 514). The content item selection system 108 includes or associates a script with the selected content item. For example, the script may be a JavaScript® script that can be embedded in the data to effect presentation of the selected content item or the script may simply be associated with the selected content item and sent with the data to effect presentation of the selected content item. The script is configured to immediately output data to indicate if the served content item is viewed on a display of a device. The data may include only data indicating that the served content item is viewed on a display of a device or the data may also include the current viewability variables or other data. In some instances, the data may be associated with a unique identifier, such as that for the content item request. In some implementations, the script may be configured to directly determine whether the served content item is viewed. In other implementations, the script may receive input from another script that monitors a viewable region with respect to the displayed resource and served content item.

The script or the other script that monitors the viewable region may determine whether the served content item is viewed based on data indicating that at least a predetermined percentage of the pixels of the served content item is visible within a viewable region of the device to which the data to effect display of the selected content item is outputted, such as that described above in reference to FIG. 3. In some implementations, the predetermined percentage of the pixels may be from 0% to 100%, inclusive. The predetermined percentage may be, for example 50% of the pixels. In some implementations, the determination that the served content item is viewed may also include a period of time for at least the predetermined percentage of the pixels of the served content item to be within the viewable region, such as that described above in reference to FIG. 3. For example, period of time may be at least 0.5 seconds, 1 second, 2 seconds, 3 seconds, 4 seconds, 5 seconds, etc. In one example, the period of time may be 1 second. In some implementations, the determination of whether the served content item is viewed may be based upon data indicating that a measurement pixel is within the viewable region, such as that described above in reference to FIG. 3. In some instances, several measurement pixels may be utilized. In yet other implementations, regions of several pixels of the served content item may be utilized to determine whether the served content item is viewed, such as that described above in reference to FIG. 3. Of course, still further implementations to determine whether the served content item has been viewed relative to the viewable region may be used as well.

The content item selection system 108 receives the data indicating whether the selected content item was viewed (step 516). In some instances, the received data may be the data outputted by the script indicating that the served content item was viewed. In other instances, the content item selection system 108 may receive data indicating that the served content item was not viewed. For example, the content item selection system 108 may receive data or determine that the served content item was not viewed if a predetermined period of time elapses without receiving data indicating that the content item was viewed from the script associated with the served content item. The predetermined period of time may be, for example, one hour, two hours, three hours, four hours, eight hours, 24 hours, a week, etc.

In some implementations, the data indicating whether the content item was viewed may be matched with the stored current viewability variables in the viewability database 160 with other data indicating whether other content items were viewed or not and the viewability variables associated corresponding thereto. The data indicating that the content item was viewed may be matched with the stored current viewability variables based on the unique identifier associated with the data indicating that the content item was viewed received from the script and the unique identifier associated with the stored current viewability variables. As indicated with the dashed line, the data indicating whether the content item was viewed and the stored current viewability variables stored in the viewability database 160 may be included in a subsequent set of view data received by the content item selection system 108 to update and refine the generated view probability predictive model.

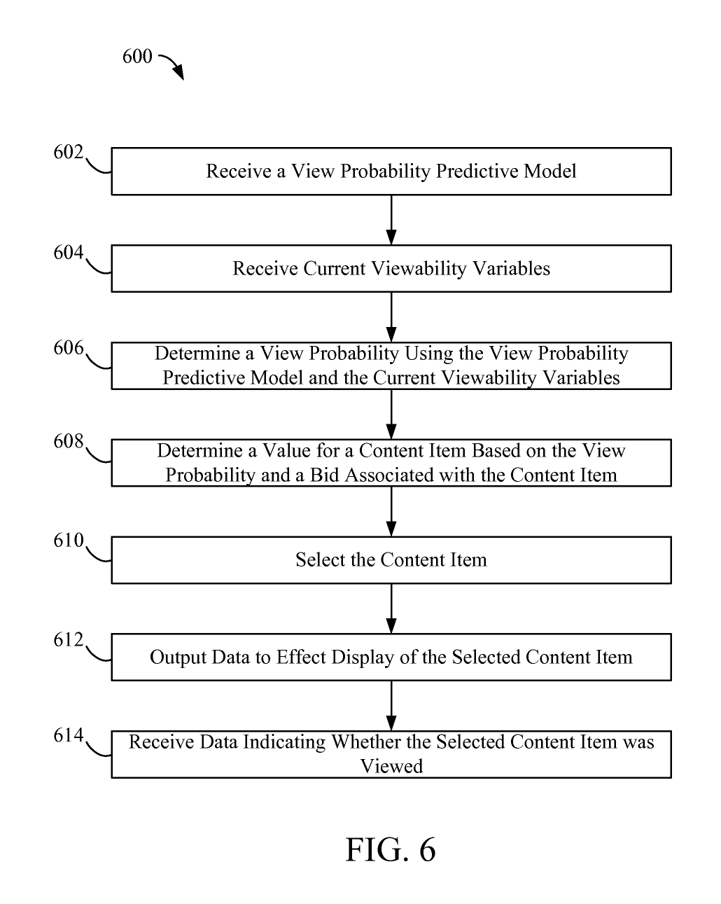

FIG. 6 depicts a flow diagram of an example process 600 for selecting and serving content items based on a view probability from a received view probability predictive model. The content item selection system 108 may receive a view probability predictive model (step 602). In some instances, the view probability predictive model may be generated offline and stored in the viewability database 160 to be retrieved by the content item selection system 108. In some implementations, the view probability predictive model may be updated on a periodic basis (e.g., per hour, per day, per week, per 1,000,000 served content items, etc.). Accordingly, the content item selection system 108 may utilize another computing system to update the view probability predictive model on a less frequent basis (thereby consuming less processing power).

The content item selection system 108 receives a set of current viewability variables (step 604). The set of current viewability variables may be based on characteristics of the user device (e.g., a type of user device, a display type of a user device, dimensions of the display), characteristics of a web browser executed on the user device (e.g., a type of web browser), settings associated with the user device (e.g., a display resolution, whether third-party content item blocking services are implemented), settings associated with the web browser executed on the user device (e.g., a height of a web browser window, a width of a web browser window, a text size setting of the web browser of the user device, a font setting of the web browser, a zoom setting of the web browser, a dimension of one or more toolbar portions of the web browser, a dimension of one or more navigation and address portions of the web browser, a dimension of one or more bookmark portions of the web browser, a dimension of one or more tab portions of the web browser, a number of tabs open in the web browser, a dimension of a scroll bar of the web browser), and/or characteristics of the resource with which the content item is to be presented (e.g., a position of the content item slot in the resource, a category of the resource, a type of the resource, an interactivity level of the resource, a ranking of the resource, a popularity of the resource).

The content item selection system 108 determines a view probability (e.g., a value between 0 and 1) using the received set of current viewability variables and the received view probability predictive model (step 606). The content item selection system 108 determines a value for a content item based on the view probability and a bid associated with the content item (step 608). The content item selection system 108 selects a content item (step 610). The content item selection system 108 outputs data to effect display of the selected content item (step 612). The content item selection system 108 includes or associates a script with the selected content item. The content item selection system 108 receives the data indicating whether the selected content item was viewed (step 614). Steps 604, 606, 608, 610, 612, and 614 may be performed similarly to steps 506, 508, 510, 512, 514, and 516 of FIG. 5.

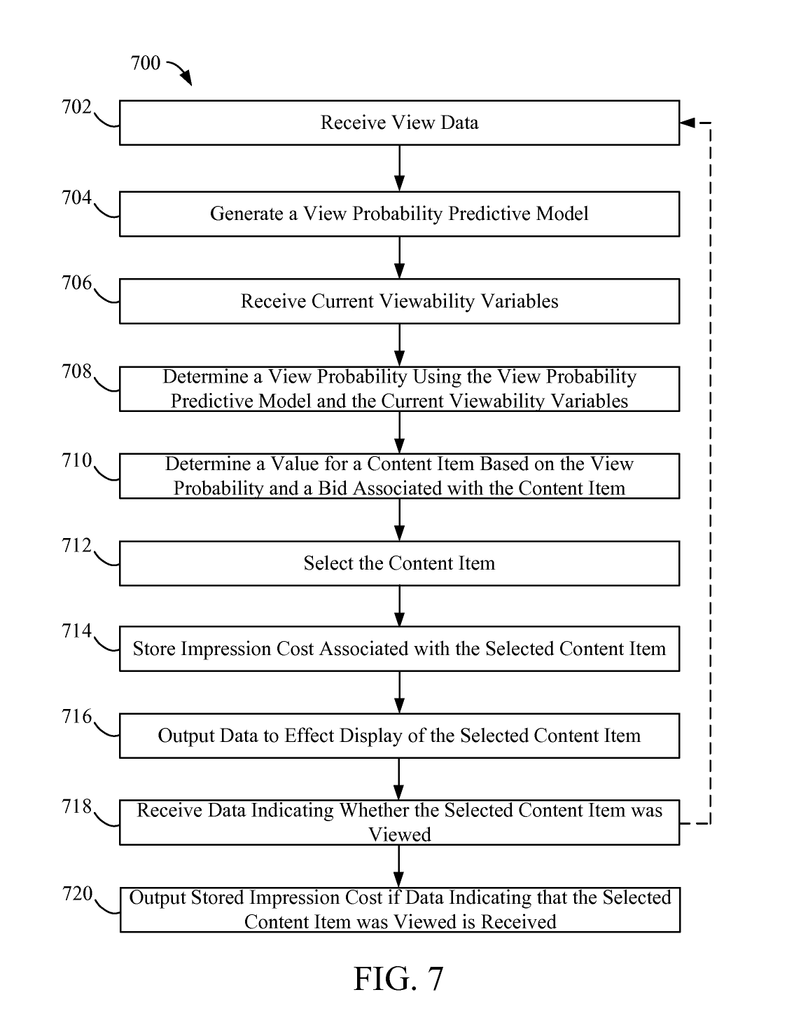

FIG. 7 depicts an example process 700 for selecting and serving content items based on a view probability and outputting an impression cost if data received by the content item selection system indicates that the selected content item was viewed. The content item selection system 108 may receive view data (step 702) from the viewability database 160 and may generate a view probability predictive model based on the received view data (step 704). The content item selection system 108 receives a set of current viewability variables (step 706) and determines a view probability (e.g., a value between 0 and 1) using the received set of current viewability variables and the generated view probability predictive model (step 708). The content item selection system 108 determines a value for a content item based on the view probability and a bid associated with the content item (step 710) and selects a content item (step 712). Steps 702, 704, 706, 708, 710, and 712 may be performed similarly to steps 502, 504, 506, 508, 510, and 512 of FIG. 5.

In the present example, the content item selection system 108 may store an impression cost associated with the selected content item (step 714). The viewed impression cost (IC) associated with the selected content item may be stored in the impression cost database 180. In one example, the impression cost is stored in a record or log of the impression cost database 180. The impression cost may be associated with a unique identifier, such as a unique identifier for the content item request, such that the impression cost may be matched with data in the view database 190 if the selected content item is viewed. The impression cost may be determined by

$$IC = \frac{{eCPM}_{runner \text{-} up}}{1000 * VP} ,$$

where eCPMᵣᵤₙₙₑᵣ₋ᵤₚ is the next highest value for another content item in the auction in which the content item is selected. As will be described below, the impression cost may be billed or charged to the third-party content provider only if the served content item is viewed.

The content item selection system 108 outputs data to effect display of the selected content item (step 716), including a script that is included or associated with data to effect display of the selected content item. Step 716 may be performed similarly to step 514 of FIG. 5. The content item selection system 108 receives the data indicating whether the selected content item was viewed (step 718). Step 718 may be performed similarly to step 516 of FIG. 5. In addition, if the content item selection system receives data indicating that the served content item was viewed, then the data may also be stored in the view database 190. In some instances, the data indicating that the served content item was viewed is associated with a unique identifier. The content item selection system 108 may match the data indicating that the served content item was viewed stored in the view database 190 with the stored impression cost stored in the impression cost database 180. The impression cost may be outputted if the content item selection system 108 determines that there is matching data indicating that the served content item was viewed stored in the view database 190. The impression cost may be outputted to a billing system such that a third-party content provider is only billed the impression cost if the received data indicates that the served content item was viewed.

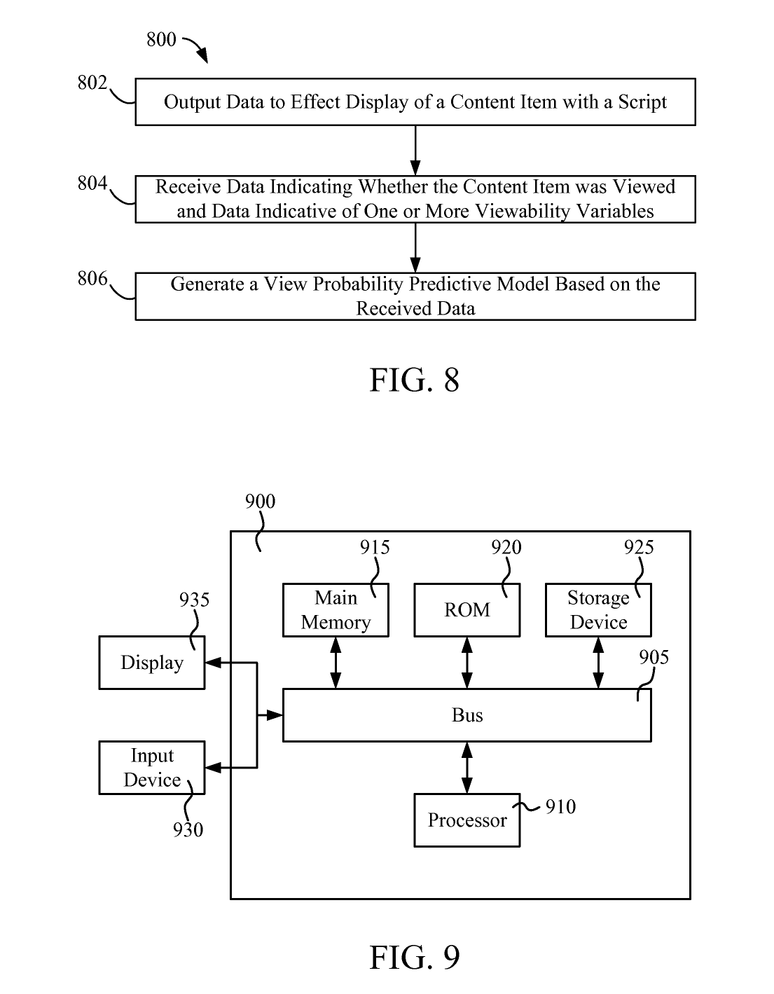

FIG. 8 depicts an example process 800 for generating a view probability predictive model using a script associated with a served content item. The content item selection system 108 outputs data to effect display of a content item with a script (step 802). For example, the script may be a JavaScript® script that can be embedded in the data to effect presentation of the content item or the script may simply be associated with the content item and sent with the data to effect presentation of the content item. The script is configured to immediately output data to indicate if the content item is viewed on a display of a device. The data may include only data indicating that the content item is viewed on a display of a device or the data may also include one or more viewability variables and/or other data. In some instances, the data may be associated with a unique identifier, such as that for a content item request to which the data to effect display of the content item is responsive. In some implementations, the script may be configured to directly determine whether the content item is viewed. In other implementations, the script may receive input from another script that monitors a viewable region with respect to the displayed resource and content item.

The script or the other script that monitors the viewable region may determine whether the content item is viewed based on data indicating that at least a predetermined percentage of the pixels of the content item is visible within a viewable region of the device to which the data to effect display of the selected content item is outputted, such as that described above in reference to FIG. 3. In some implementations, the predetermined percentage of the pixels may be from 0% to 100%, inclusive. The predetermined percentage may be, for example 50% of the pixels. In some implementations, the determination that the content item is viewed may also include a period of time for at least the predetermined percentage of the pixels of the served content item to be within the viewable region, such as that described above in reference to FIG. 3. For example, period of time may be at least 0.5 seconds, 1 second, 2 seconds, 3 seconds, 4 seconds, 5 seconds, etc. In one example, the period of time may be 1 second. In some implementations, the determination of whether a served content item is viewed may be based upon data indicating that a measurement pixel is within the viewable region, such as that described above in reference to FIG. 3. In some instances, several measurement pixels may be utilized. In yet other implementations, regions of several pixels of the served content item may be utilized to determine whether the served content item is viewed, such as that described above in reference to FIG. 3. Of course, still further implementations to determine whether the served content item has been viewed relative to the viewable region may be used as well.

The content item selection system 108 receives data indicating whether the content item was viewed and data indicative of one or more viewability variables (step 804). In some instances, the received data indicating whether the content item was viewed may be the data outputted by the script. In other instances, the content item selection system 108 may receive data indicating that the content item was not viewed. For example, the content item selection system 108 may receive data or determine that the content item was not viewed if a predetermined period of time elapses without receiving data indicating that the content item was viewed from the script associated with the content item. The predetermined period of time may be, for example, one hour, two hours, three hours, four hours, eight hours, 24 hours, a week, etc.

The data indicative of one or more viewability variables may be received as part of the data indicating whether the content item was viewed from the script or the data indicative of one or more viewability variables may be received from another source (e.g., another script, in response to a request to a browser on which the content item is presented, etc.).

The data indicative of the one or more viewability variables may be based on characteristics of the user device (e.g., a type of user device, a display type of a user device, dimensions of the display), characteristics of a web browser executed on the user device (e.g., a type of web browser), settings associated with the user device (e.g., a display resolution, whether third-party content item blocking services are implemented), settings associated with the web browser executed on the user device (e.g., a height of a web browser window, a width of a web browser window, a text size setting of the web browser of the user device, a font setting of the web browser, a zoom setting of the web browser, a dimension of one or more toolbar portions of the web browser, a dimension of one or more navigation and address portions of the web browser, a dimension of one or more bookmark portions of the web browser, a dimension of one or more tab portions of the web browser, a number of tabs open in the web browser, a dimension of a scroll bar of the web browser), and/or characteristics of the resource with which the content item is to be presented (e.g., a position of the content item slot in the resource, a category of the resource, a type of the resource, an interactivity level of the resource, a ranking of the resource, a popularity of the resource). The data indicating whether the content item was viewed and the one or more viewability variables are matched and stored, such as in the viewability database 160.

The content item selection system 108 may generate a view probability predictive model based on the received data (step 806). The content item selection system 108 may generate the view probability predictive model using logistic regression based on the received data, as described in greater detail herein. The view probability predictive model may be stored, such as in the viewability database 160, and/or used by the content selection system 108 or output to another system.

FIG. 9 is a block diagram of a computer system 900 that can be used to implement the user device 102, content item selection system 108, third-party content server 104, etc. The computing system 900 includes a bus 905 or other communication component for communicating information and a processor 910 or processing module coupled to the bus 905 for processing information. The computing system 900 can also include one or more processors 910 or processing modules coupled to the bus for processing information. The computing system 900 also includes main memory 915, such as a RAM or other dynamic storage device, coupled to the bus 905 for storing information, and instructions to be executed by the processor 910. Main memory 915 can also be used for storing position information, temporary variables, or other intermediate information during execution of instructions by the processor 910. The computing system 900 may further include a ROM 920 or other static storage device coupled to the bus 905 for storing static information and instructions for the processor 910. A storage device 925, such as a solid state device, magnetic disk or optical disk, is coupled to the bus 905 for persistently storing information and instructions. Computing device 900 may include, but is not limited to, digital computers, such as laptops, desktops, workstations, personal digital assistants, servers, blade servers, mainframes, cellular telephones, smart phones, mobile computing devices (e.g., a notepad, e-reader, etc.) etc.

The computing system 900 may be coupled via the bus 905 to a display 935, such as a Liquid Crystal Display (LCD), Thin-Film-Transistor LCD (TFT), an Organic Light Emitting Diode (OLED) display, LED display, Electronic Paper display, Plasma Display Panel (PDP), and/or other display, etc., for displaying information to a user. An input device 930, such as a keyboard including alphanumeric and other keys, may be coupled to the bus 905 for communicating information and command selections to the processor 910. In another implementation, the input device 930 may be integrated with the display 935, such as in a touch screen display. The input device 930 can include a cursor control, such as a mouse, a trackball, or cursor direction keys, for communicating direction information and command selections to the processor 910 and for controlling cursor movement on the display 935.

According to various implementations, the processes and/or methods described herein can be implemented by the computing system 900 in response to the processor 910 executing an arrangement of instructions contained in main memory 915. Such instructions can be read into main memory 915 from another computer-readable medium, such as the storage device 925. Execution of the arrangement of instructions contained in main memory 915 causes the computing system 900 to perform the illustrative processes and/or method steps described herein. One or more processors in a multi-processing arrangement may also be employed to execute the instructions contained in main memory 915. In alternative implementations, hard-wired circuitry may be used in place of or in combination with software instructions to effect illustrative implementations. Thus, implementations are not limited to any specific combination of hardware circuitry and software.

Although an example computing system 900 has been described in FIG. 9, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The term “data processing apparatus” or “computing device” or “processing circuit” encompasses all kinds of apparatus, devices, and machines for processing data, including by way of example a programmable processor, a computer, a system on a chip, or multiple ones, a portion of a programmed processor, or combinations of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of what may be claimed, but rather as descriptions of features specific to particular embodiments. Certain features described in this specification in the context of separate embodiments can also be implemented in combination in a single implementation. Conversely, various features described in the context of a single implementation can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products embodied on tangible media.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1.-20. (canceled)

21. A method comprising:
receiving, at a processing module, one or more viewability variables;
determining, using the processing module, a view probability based on a view probability predictive model and the received one or more viewability variables;
determining, using the processing module, a value for a content item based, at least in part, on the view probability and a bid associated with the content item; and
selecting the content item based, at least in part, on the determined value.

22. The method of claim 21 further comprising:
ranking a plurality of content items based on a determined value for each of the plurality of content items.

23. The method of claim 21 further comprising:
receiving, at the processing module, view data including a plurality of viewed impressions, wherein each viewed impression of the plurality of viewed impressions is associated with the one or more viewability variables; and
generating, using the processing module, the view probability predictive model based, at least in part, on the view data.

24. The method of claim 23, wherein the view probability predictive model is generated using a logistic regression function.

25. The method of claim 21, wherein the viewability variables are received with a content item request.

26. The method of claim 25, wherein the viewability variables are included in a URL.

27. The method of claim 21, wherein the determination of the value is based on multiplying the view probability by the bid associated with the content item.

28. The method of claim 27, wherein the bid is a CPMV bid.

29. The method of claim 21 further comprising:
storing, in a computer readable medium, the received one or more viewability variables with a unique identifier.

30. The method of claim 21, wherein the one or more viewability variables include one of a type of device, a display type of the device, a dimension of the display, a type of web browser, a display resolution, whether a third-party content item blocking service is implemented, a height of a web browser window, a width of the web browser window, a text size setting of the web browser, a font setting of the web browser, a zoom setting of the web browser, a dimension of a toolbar portion, a dimension of a navigation and address portion, a dimension of a bookmark portion, a dimension of a tab portion, a number of tabs open, a dimension of a scroll bar, a position of a content item slot in a resource, a category of the resource, a type of the resource, an interactivity level of the resource, a ranking of the resource, a popularity of the resource, formulae derived from dimensions of the web browser and a location of an area where the selected content item is to be shown, dimensions of an area where the selected content item is to be shown, or part or all of an address of the resource.

31. A system comprising:
a processing module; and.
a storage device storing instructions that, when executed by the processing module, cause the processing module to perform operations comprising:
receiving one or more viewability variables,
determining a view probability based on a view probability predictive model and the received one or more viewability variables,
determining an eCPM value for a content item based, at least in part, on the view probability and a CPMV bid associated with the content item,
selecting the content item based, at least in part, on the value, and
outputting data to effect display of the selected content item.

32. The system of claim 31, wherein the instructions that cause the processing module to perform operations further comprising:
ranking a plurality of content items based on a determined value for each of the plurality of content items.

33. The system of claim 31, wherein the eCPM value is determined by multiplying the view probability and the CPMV bid.

34. The system of claim 31, wherein the view probability is a value between 0, inclusive, and 1, inclusive.

35. The system of claim 31, wherein the determination of the eCPM value includes using a default value for an input of the view probability predictive model if the one or more viewability variables do not include a value for the input.

36. The system of claim 31, wherein the one or more viewability variables include one of a type of device, a display type of the device, a dimension of the display, a type of web browser, a display resolution, whether a third-party content item blocking service is implemented, a height of a web browser window, a width of the web browser window, a text size setting of the web browser, a font setting of the web browser, a zoom setting of the web browser, a dimension of a toolbar portion, a dimension of a navigation and address portion, a dimension of a bookmark portion, a dimension of a tab portion, a number of tabs open, a dimension of a scroll bar, a position of a content item slot in a resource, a category of the resource, a type of the resource, an interactivity level of the resource, a ranking of the resource, a popularity of the resource, formulae derived from dimensions of the web browser and a location of an area where the selected content item is to be shown, dimensions of an area where the selected content item is to be shown, or part or all of an address of the resource.

37. A computer-readable storage device storing instructions that, when executed by a processing module, cause the processing module to perform operations comprising:
receiving one or more viewability variables with a content item request,
determining a view probability based on a view probability predictive model and the received one or more viewability variables,
determining a value for a content item based, at least in part, on the view probability and a bid associated with the content item, and
selecting the content item based, at least in part, on the value and in response to the content item request.

38. The computer-readable storage device of claim 37, wherein the bid is a CPMV bid.

39. The computer-readable storage device of claim 38, wherein the determination of the value includes using a default value for an input of the view probability predictive model if the one or more viewability variables do not include the input.

40. The computer-readable storage device of claim 39, wherein the default value is an average of previous viewability variables corresponding to the input.
